(19) United States
(12) Patent Application Publication
(10) Pub. No.: US 2012/0160336 A1
(43) Pub. Date: Jun. 28, 2012

(54) Devices and Methods for Varying the Geometry and Volume of Fluid Circuits

(75) Inventors: Arne F. Myran, (US); David S. Laker, (US)

(73) Assignee: Aqualyng AS, Vanvikan (NO)

(21) Appl. No.: 13/292,183

(22) Filed: Nov. 9, 2011

Related U.S. Application Data
(60) Provisional application No. 61/427,516, filed on Dec. 28, 2010.

(51) Int. Cl. F15D 1/00

(52) U.S. Cl. 137/14; 137/561 R

(57) ABSTRACT

A device and method for varying the pressure in a fluid circuit through altering the geometry and volume of the fluid circuit to equalize the pressure differential across components in the circuit such as valves to facilitate the operation of the valve or other components within the fluid circuit. An expandable/retractable mechanism may be in communication with a pressure vessel in the fluid circuit, and may be operable to vary the interior geometry, and consequently the volume, of the vessel to cause a pressure increase or decrease in the vessel, thereby equalizing pressure across a valve on the vessel and facilitating operation of the valve.

### CROSS REFERENCE TO RELATED APPLICATION

This application claims priority to U.S. Provisional Patent Application Ser. No. 61/427,516, filed Dec. 28, 2010, which is herein incorporated by reference in its entirety.

### FIELD OF THE INVENTION

The present invention generally relates to apparatus, systems and methods for varying the geometry and volume of a fluid circuit to control pressure.

### BACKGROUND OF THE INVENTION

Fluid circuits for a variety of applications typically include combinations of components such as vessels, flow paths, (i.e., conduits such as tubes or pipes) and valves. Fluid circuits typically operate under pressures which can vary, often in cyclical fashion, across different stages of the circuit. These pressurizations are typically controlled by valves (or series of valves), and pumps.

Due in part to operating pressures, these valves or other components in the fluid circuit often require large amounts of energy to operate and exhibit elevated levels of wear and tear. Although occurring with valves of all sizes, such conditions are more commonly encountered with larger valves. In such cases, it can take a large amount of energy and/or processing time to change a valve's position (e.g., from an open position to a closed position or vice versa) due to large pressures that can develop with the fluid that is being contained by the valve.

Other problems often associated with moving the operating components of a valve of any size under dynamic conditions include water hammer and cavitation. A large variation in pressure during the initial stage of opening a valve could result in fluid velocities that exceed the speed of sound, causing cavitation. Cavitation is a particularly undesirable condition that can cause noise, vibrations and/or damage to the valve components.

The problems discussed above are often encountered in energy recovery devices and processes and, in particular, seawater desalination processes. Desalination of seawater is commonly accomplished through Seawater Reverse Osmosis (SWRO) which is a pressure/energy intensive membrane process. To reduce the energy costs in such processes, isobaric energy recovery devices are often used. These isobaric devices recover the latent or potential energy contained in the concentrate stream (a.k.a. brine or waste) of the SWRO process by direct transfer of the latent energy from the concentrate stream to the incoming low pressure seawater feed stream. The latent energy contained in the waste stream typically contains 60% of the total energy used to accomplish the SWRO desalination process. Over 90% of the energy of the waste stream can thus be recovered. Installations utilizing isobaric energy recovery methods are found in many parts of the world today in varying capacities of up to about 106 million gallons per day (about 400,000 m³/day) of potable water and energy recovery processes are generally used on most such installations. While isobaric energy recovery systems in SWRO plants already operate with efficiencies in the mid-90% range, further improvements can bring about significant operational cost savings over the 20-30 year operating life of the facility. Improvements may include direct gains in efficiency or indirect improvements in reliability and availability of the equipment and components.

The process of recovering the latent energy in the form of pressure in the concentrate stream of the seawater reverse osmosis process typically involves a continuous overlapping cycle between two or more vessels or sets of vessels. These vessels are operated from approximately atmospheric pressure to pressures of around 1200 pounds per square inch (psi), typically on the order of 900 psi. In each cycle, the vessels are brought up to working pressure and/or depressurized rapidly using the “actuation” valves to control flow by, e.g., switching stream flows in and out of the vessels. Because of the often large pressure that develops on one side of a valve, it can take an inordinate amount of energy and processing time to actuate the valve from its closed position to its open position.

Some known technological advances aimed at improving efficiencies of seawater desalination processes are focused on improving pumping efficiencies. Others have addressed assisting valve operation in certain applications. For example, in certain such advances, there is direct injection of energy to the valve body to assist operation of the valve body itself, where the fluid being contained by the valve remains at its pressure but the injected energy augments the force on the valve body to facilitate actuation of the valve. While intended to assist valve operation, this also can further contribute to increased wear and tear on the valve component as will be discussed below, in addition to the “ordinary” wear and tear discussed above.

Additional energy losses in each operating cycle of the SWRO process can be attributed to dynamic changes in the geometry of the fluid circuit caused by dynamic variations in the properties, process, and ambient conditions of the working fluid medium (seawater) and the material of construction of the pressure vessels and associated components of the fluid circuit described herein.

Water, although commonly thought of as an incompressible fluid as indicated by its finite bulk modulus (1), is not strictly incompressible. While it may be said that water is nearly incompressible, this again is a relative term. Laboratory-prepared, double-distilled water having a density expressed as 1.0000 grams per cubic centimeter (g/cm³) at a temperature of four degrees Centigrade is the standard used to define the density of water. The density of seawater, which contains dissolved chemicals and solids, ranges between 1.025 and 1.048 g/cm³. The benchmark used in seawater reverse osmosis desalination plants is about 1.035 g/cm³, at 25 degrees centigrade, but even this generally does not account for any dissolved gases present; for example, if there is a storm at sea or the waters are rough, then seawater may become supersaturated with oxygen. Seawater as applied to desalination by reverse osmosis normally contains dissolved oxygen close to its saturation point, which in turn increases the vapor pressure and the compressibility of seawater. Therefore, in each operating cycle of the isobaric process, each vessel can incur energy losses due to the compressibility of seawater. Therefore, in each operating cycle, the seawater must be compressed by an additional compression volume (dV_{c}) to become effectively incompressible. Existing isobaric energy devices do not compensate for dV_{c}.

In addition, the materials used to manufacture the vessels and associated fluid circuit components (such as tubing, piping, and valves—collectively “containment systems”) are also subject to stresses and elastic deformation. With seawater under very high pressures within these containment systems, the materials yield to a certain extent on each pressurizing cycle, thereby slightly increasing the volume of the containment system. This increase in volume caused by material yield factors of the containment system (“dVₘ”) is also not addressed efficiently in existing isobaric energy recovery devices.

Conventional isobaric devices “leak” back the high pressure concentrate from the SWRO membranes into the containment system to account for the changes in volume caused by seawater and material compressibilities (dV_{c}+dVₘ) discussed above. Therefore, in conventional isobaric devices, there is also no energy recovered from the concentrate of volume (dV_{c}+dVₘ). This contributes to further energy losses during operation of the desalination plant.

While the net energy loss generated from sources such as those described above—valve operation, seawater compressibility and the materials used in the containment system—in any single cycle may be relatively small, their impact can become significant in aggregate. For example, work exchangers installed in commercial seawater desalination plants typically run 1-2 million cycles in a year. Therefore, all these smaller “per-cycle” losses can result in significant annual operating expense of a plant. In addition to these increased costs, and perhaps of more importance, these problems cause increased stress, and thereby increased wear and tear on the valves, which in turn results in shorter equipment cycles and a further increase in maintenance and replacement costs.

### SUMMARY OF THE INVENTION

The aforementioned problems can be resolved with the present invention which will be described in detail below, with benefits including longer equipment lifecycles and reduced operating and maintenance costs.

When operating valves or other components in a fluid circuit, it is beneficial to pressurize or depressurize one or more parts of the fluid circuit, for example, in order to facilitate faster, easier and/or more energy efficient operation of a valve or component. The present invention, in its various embodiments, provides for a device and method that can vary the pressure in a particular part of the fluid circuit through altering the volume of that portion of the fluid circuit under pressure. More specifically, the present invention equalizes the pressure differential across a valve to facilitate the operation of valves and other components within the fluid circuit. In accordance with one aspect of the present invention, in a described illustrative embodiment, an expandable/retractable mechanism is attached in communication with a pressure vessel in the fluid circuit, where the mechanism is operable to vary the volume of the vessel to cause a pressure increase or decrease in the vessel, thereby facilitating the operation of a valve or valve in the fluid circuit.

It will be appreciated by those skilled in the art that the foregoing brief description and the following detailed description are exemplary and explanatory; they and are not intended to be restrictive or limiting. Thus, although the accompanying drawings, together with the detailed description, serve to explain the principles of the various embodiments of the devices and methods for varying the geometry and volume of fluid circuits, many other embodiments of the devices and methods are possible without departing from the scope of the invention as outlined in the claims.

### BRIEF DESCRIPTION OF THE DRAWINGS

Aspects, features, and advantages of the disclosed devices and methods, both as to their structure and operation, will be understood and will become more readily apparent when considered in light of the following description of illustrative embodiments made in conjunction with the accompanying drawings, wherein:

FIG. 1 is an exemplary embodiment of the devices and methods for varying the geometry and volume of fluid circuits, implemented in a seawater reverse osmosis (SWRO) hydraulic circuit;

FIGS. 2A, 2B, 2C and 2D show different views and positions of an exemplary device for varying the volume of a fluid circuit and its implementation in a pressure vessel, according to an exemplary embodiment of the devices and methods for varying the geometry and volume of fluid circuits;

FIGS. 3A and 3B show exemplary embodiments of a device for varying the volume of a fluid circuit in two operating positions of a pressure vessel application;

FIG. 4 is an exemplary device for varying the volume of a fluid circuit, according to another alternative embodiment; and

FIGS. 5 A-E is a device for varying the volume of a fluid circuit, according to another alternative embodiment of the present devices and methods for varying the geometry and volume of fluid circuits.

### DETAILED DESCRIPTION OF THE PREFERRED EMBODIMENT

Illustrative and alternative embodiments and operational details of systems, methods and devices for varying the volume of a fluid circuit to control pressure will be discussed in detail below with reference to the figures provided.

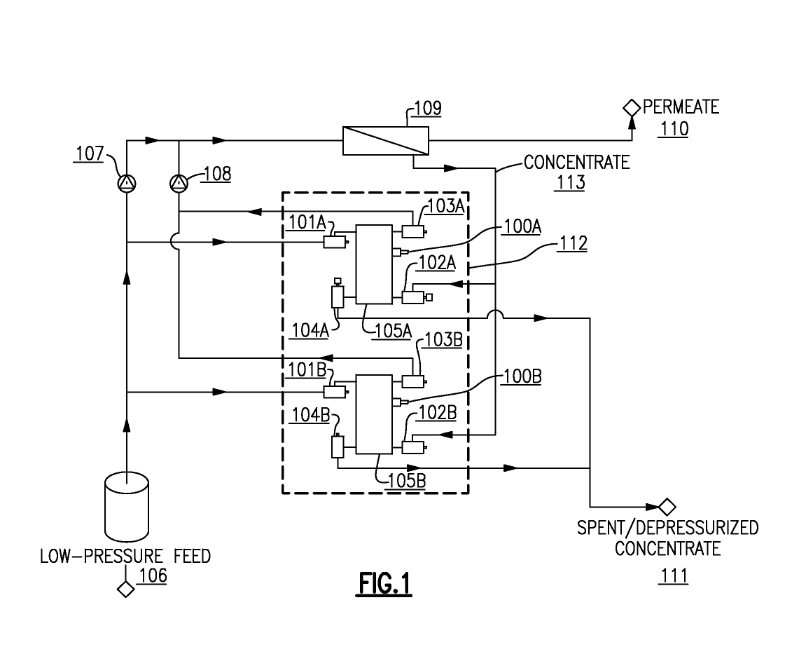

FIG. 1 shows an illustrative embodiment of the devices and methods for varying the geometry and volume of fluid circuits implemented in a SWRO (SeaWater Reverse Osmosis) hydraulic circuit that includes an isobaric energy recovery system 112. The circuit shown is useful in a desalination process where low pressure seawater 106, by means of a seawater high-pressure pump 107, is fed through a reverse osmosis membrane system 109 to generate potable permeate 110 and concentrate feed 113 to system 112.

The isobaric energy recovery system 112 of the illustrative embodiment consists of two pressure vessels 105A and 105B. These pressure vessels are also known as work exchanger vessels or pressure exchanger vessels in the energy recovery and desalination process industries. Each pressure vessel 105A/105B is connected in this embodiment to four valves: an inlet valve 101A/101B to admit low pressure seawater feed 106; an inlet valve 102A/102B to admit concentrate feed 113; an outlet valve 103A/103B that sends a fresh charge of seawater pressurized by the concentrate through a booster pump 108 to the reverse osmosis system 109; and an outlet valve 104A/104B for discharging spent/depressurized concentrate 111 from vessel 105A/105B.

In the illustrative embodiment, each pressure vessel is equipped with a “Volumizer™” (all rights reserved) mechanism 100. Although only one Volumizer per vessel is shown (100A and 100B) for purposes of illustration, any number of Volumizers may be disposed in communication with any given vessel, as will be explained below. In the illustrated embodiment, Volumizer 100A is connected to pressure vessel 105A, and Volumizer 100B is connected to pressure vessel 105B. Each Volumizer is deployable and retractable such that it alters the internal geometry, and consequently volume, of the vessel to which it is connected. In its deployed state, the Volumizer reduces the internal volume of the pressure vessel by an amount proportional to the volume of the portion of the Volumizer which is deployed within the vessel internal volume. Conversely, when retracted, the Volumizer increases the internal volume of the pressure vessel by an amount proportional to the volume of the portion of the Volumizer which is retracted from the vessel internal volume. When the contents of the vessel in communication with the Volumizer are under pressure, such operation of the Volumizer will serve, as will be understood by one skilled in the art, to increase (when internal volume is decreased by deployment of the Volumizer) or decrease (when internal volume is increased by deployment of the Volumizer) the pressure in the vessel.

The illustrative hydraulic circuit in the desalination process shown in FIG. 1 operates in repeating cycles. Each cycle can be described as follows: As a starting condition, all valves connected to vessel 105B are closed and the Volumizer 100B is retracted. Outlet valve 104B is opened, which causes inlet valve 101B to open, allowing a low-pressure feed (seawater) 106 to fill pressure vessel 105B through passive (one-way) valve 101B which is opened, as valve 102B and 103B remain closed. In one exemplary embodiment, valve 102B is an actuated valve, and valve 103B is a passive, one-way check valve.

At the end of the fill cycle, Volumizer 100B is deployed from its initial refracted state to move toward the deployed position, causing the volume in the interior of vessel 105B to decrease, which in turn causes the pressure within the interior of the vessel to rise. This pressure increase also causes passive valve 101B to close. Through deployment of Volumizer 100B the pressure in vessel 105B rises, in the illustrative embodiment, to a point approximately equal to the concentrate pressure on valve 102B, equalizing the pressure differential which had existed across the valve 102B and facilitating opening of valve 102B, as there is potentially no pressure differential across the valve, or at least a significantly reduced pressure differential. At the same time, passive valve 103B opens in response to the increased pressure differential between the vessel pressure being supplied by the concentrate and the suction side (feed side) of booster pump 108. The opening of valve 103B is similarly facilitated as the pressure differential across valve 103B has also reached equilibrium, or substantially close to equilibrium.

The concentrate under pressure acts directly upon the fresh charge of seawater that has now reached the same pressure as the concentrate and the fresh seawater moves through valve 103B where the pressure is boosted by the booster pump 108 to equal the pressure of the seawater high-pressure pump 107 discharge, (typically a pressure boost of one-half bar). The combined discharge of both pumps 108 and 107 enters the reverse osmosis process 109 where the salt in the seawater is separated by a membrane process leaving approximately 60% of the total seawater feed as a pressurized concentrate stream of seawater 113 and the other 40% as low-pressure, potable water, called permeate 110. The concentrate stream is still at high pressure, containing almost all of the energy that it took to get it to that state. Because of the continuous process, the energy can be harnessed and directed back into the process as described in the continuation of the cycle.

As the concentrate nears the end of pushing out the fresh seawater from vessel 105B, vessel 105A becomes active in the process, with, in the illustrative embodiment, a momentary operational overlap of both vessels, before vessel 105A takes over the process. The pressurization cycle of vessel 105A is similar to the cycle discussed above with respect to pressurization of vessel 105B, with Volumizer 100A bringing the pressure of vessel 105A up to the point where actuated valve 102A may be opened with less energy and the fresh seawater pushed out by the concentrate through valve 103A. As will be understood, both vessels may contribute to the process before the concentrate in vessel 105B can flow through valve 103B behind the fresh seawater. At that point, the Volumizer in 105B is retracted causing the pressure in vessel 105B to be lower than the pressure on the discharge side of valve 103B and valve 103B is allowed to close. As the pressure decays in vessel 105B, actuation of valve 104B to an open state is facilitated to atmosphere, which allows passive valve 101B to open again, admitting another charge of fresh seawater, thus ending the first cycle and beginning the next cycle.

In the illustrative embodiment, the process cycle continues by alternating the pressurizing and depressurizing stages between the two pressure vessels 105A and 105B as described above. While the two pressure vessels alternate between pressurized and depressurized states in different segments of the cycle, it will be understood that such alternating of states is not necessarily discrete, in that there may be some overlap of the vessel states to ensure that the process is continuous and e.g., avoids pressure excursions due to valve actuation time.

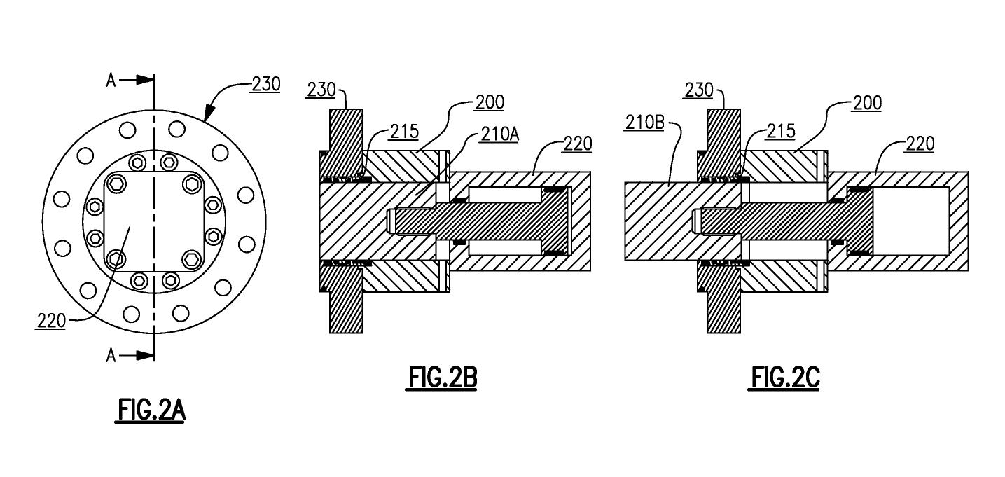

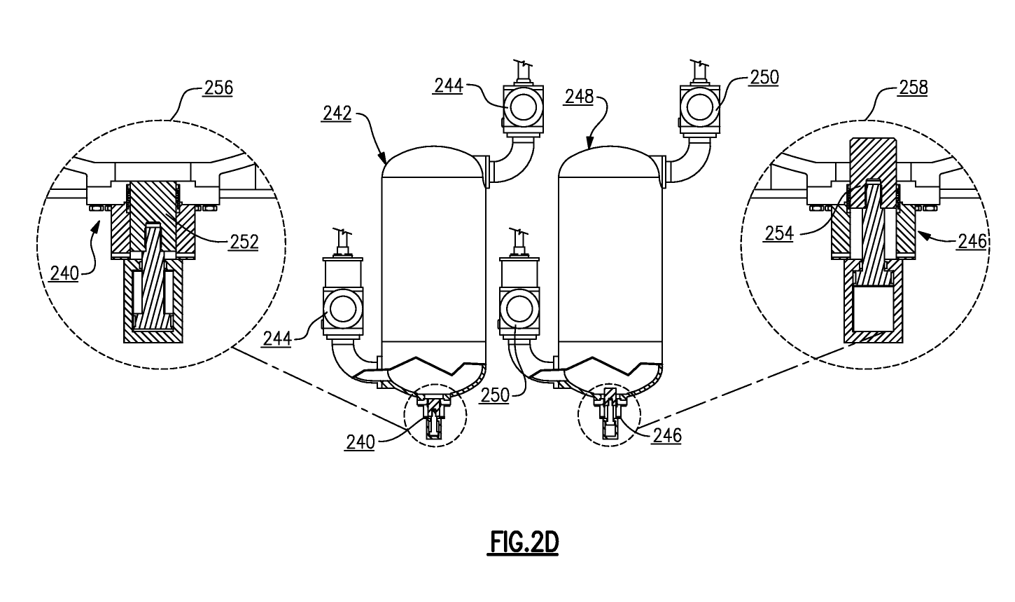

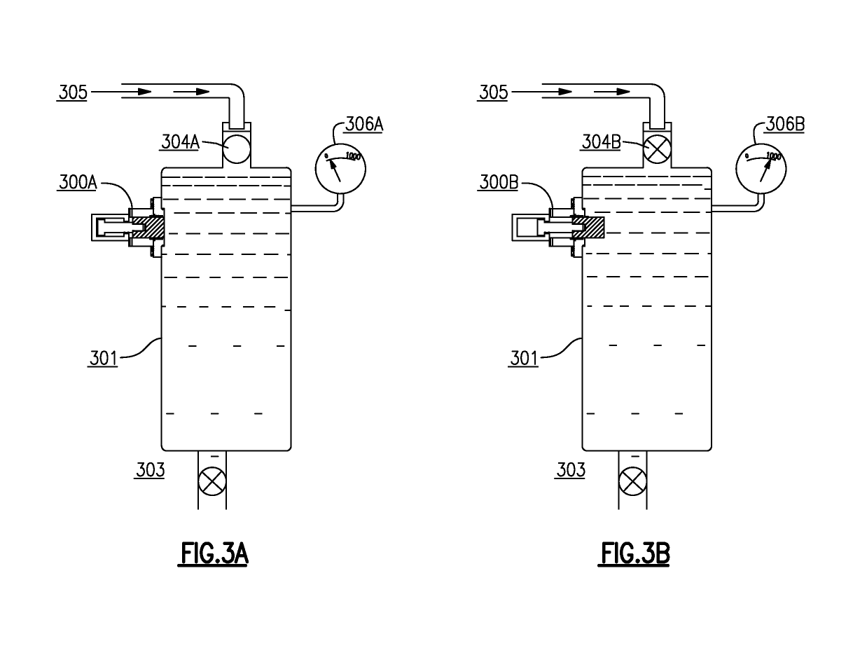

The Volumizer mechanism 100A/100B of FIG. 1 discussed above with respect to the illustrative embodiment can be implemented in different ways as will be understood by one skilled in the art in accordance with the principles disclosed herein. For purposes of explanation, FIGS. 2A-D show different views and positions of an illustrative embodiment of the Volumizer mechanism that is implemented as an actuator driven piston attached to a vessel in a fluid circuit. FIGS. 2A, 2B and 2C show different views and positions of the illustrative Volumizer housed within an extension flange 200 which is connected to the vessel or any other part of a fluid circuit through flange 230. Contained within the Volumizer housing is a moveable piston 210 that is sealed through a packing box 215. The piston is connected to a compact hydraulic cylinder/actuator mechanism 220 so that it can be retracted (position 210A) or deployed (position 210B) into the vessel or fluid circuit, so as to increase (when deployed) or decrease (when retracted) the internal volume of the fluid circuit. A control unit (not shown) controls the actuator to drive the piston.

FIG. 2D illustrates an exemplary embodiment of a portion of a device for varying the geometry and volume of a fluid circuit. As shown in FIG. 2D, one or more Volumizers, similar to the Volumizer shown in FIGS. 2A-C, may be mounted to a pressure vessel and configured to interact with the pressure vessel to change the interior volume of the vessel. For example, as shown in FIG. 2D, a first Volumizer 240 of the type shown in FIGS. 2A-C may be mounted to a first pressure vessel 242 which has several valves 244 that connect first pressure vessel 242 to other portions of a fluid circuit. A second Volumizer 246 may be mounted to the bottom of a second pressure vessel 248, which also has several valves 250 connecting second pressure vessel 248 to other portions of the fluid circuit. Although Volumizers 240 and 246 are shown mounted to the bottom of their respective pressure vessels, it should be understood that the Volumizers could also be mounted in any other suitable location on the pressure vessels. Similarly, although only two valves are shown for each pressure vessel, it should be understood that any number of valves may be used for each pressure vessel.

In one exemplary embodiment, a process cycle may alternatingly pressurize and depressurize two pressure vessels within the fluid circuit. For example, as shown in FIG. 2D, a first Volumizer 240 may include a first actuatable member 252 in communication with the interior volume of first pressure vessel 242, and second Volumizer 246 may include a second actuatable member 254 in communication with the interior volume of second pressure vessel 248. Detailed view 256 shows a detailed cross-sectional view of first Volumizer 240, including first actuatable member 252. Detailed view 258 shows a detailed cross-sectional view of second Volumizer 246, including second actuatable member 254.

In one exemplary embodiment, first actuatable member 252 and the second actuatable member 254 are configured to work together to alternatingly pressurize and depressurize the first and second pressure vessels 242, 248 in a cyclical manner such that the interior pressure of first pressure vessel 242 increases as the interior pressure of second pressure vessel 248 decreases, and the interior pressure of first pressure vessel 242 decreases as the interior pressure of second pressure vessel 248 increases. As shown in FIG. 2D, when first actuatable member 252 is in a retracted position, second actuatable member 254 may be in an extended or deployed position, thus reducing the volume within second pressure vessel 248. In one exemplary embodiment, as first actuatable member 252 moves from a retracted position to an extended position, second actuatable member 254 moves from an extended position to a retracted position, the result being that the two pressurized vessels are cyclically pressurized and depressurized. That is, first pressure vessel 242 is pressurized while second pressure vessel 248 is depressurized, and first pressure vessel 242 is depressurized while second pressure vessel 248 is pressurized.

Actuatable members 252, 254 may be controlled by a control unit (not shown), and may be actuated using any suitable method, including, but not limited to, electrically, hydraulically, and pneumatically. In one embodiment,

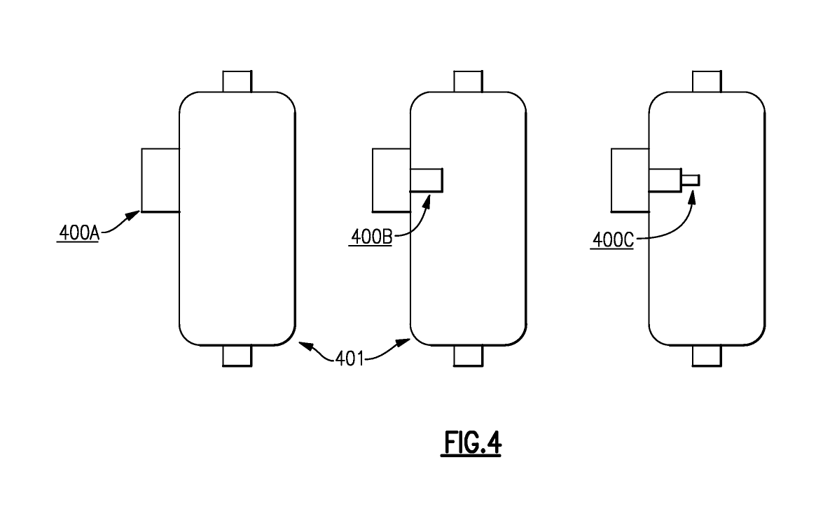

FIG. 3A and FIG. 3B show two operating positions (300A and 300B) of the Volumizer of FIG. 2A in an illustrative embodiment of a pressure vessel application. FIG. 3A shows a pressure vessel 301 with a Volumizer mounted through the wall of the pressure vessel. The pressure vessel 301 is filled, (drain valve 303 closed) with a liquid 305 through an open fill valve 304A at a first, typically atmospheric, pressure to its maximum capacity with the piston of the Volumizer retracted (300A). The fill valve is then closed (304B), and the pressure inside the pressure vessel will register a normalized (e.g., zero) pressure on a standard pressure gauge 306A. In FIG. 3B, the piston of the Volumizer is then extended (300B) into the space occupied by the liquid in the pressure vessel, thereby displacing some of the liquid, causing the interior volume of the vessel to decrease, and causing the pressure inside the pressure vessel to rise to the desired operating pressure. As previously noted, some of the liquid may compress based on its level of compressibility to accommodate the piston. For instance, seawater may compress due to gases entrained in the seawater along with the natural compressibility factor of seawater. The pressure vessel may also swell or gain volume to the extent of the mechanical properties of the pressure vessel. The overall net effect will however, despite these losses (i.e., due to compressibility of the fluid or mechanical changes), result in an increase of pressure, as the Volumizer would be designed to compensate for such losses while still achieving the desired result of increased overall pressure. In other words, the Volumizer may be configured to dynamically compensate for fluctuations in the compressibility of the fluid caused by fluctuations in the process conditions.

In alternative embodiments, the Volumizer mechanism can be implemented with different control mechanisms as will be understood. For example, in one embodiment, the Volumizer can be operable in open loop fashion in one of multiple predetermined states: retracted (fully or partially to a predetermined position) or deployed (fully or partially to a predetermined position). In a closed loop alternate implementation, the Volumizer deployment and retraction can be variably controlled through e.g., a pressure feedback loop where the pressure of the interior vessel is fed back to a control mechanism of the Volumizer to control deployment and retraction of the Volumizer or a position feedback loop where the position of deployable Volumizer (i.e., piston) is fed back to a control mechanism of the Volumizer to control deployment and retraction of the Volumizer. In one embodiment of such a closed loop implementation, the piston is moved into the volume of the pressure vessel to a point where all the mechanical and natural factors have been overcome, and the piston stopped at a point where a desired pressure within the pressure vessel has been attained. This point can be usually determined by use of a pressure switch which will automatically compensate for varying conditions of dissolved gases and temperature. For typical SWRO operating conditions, this pressure is about 70 bar. Under these conditions it would be difficult to open either of the valves as there is a total differential pressure across the closed valves. If the piston of the Volumizer is withdrawn to its starting position, the pressure within the pressure vessel will fall back to the starting pressure (i.e., zero, near zero, or an effective zero) again, and the valves may be opened with less or little effort (energy). As indicated, alternatively, control loop closure can be about Volumizer position.

While the use of the piston is one embodiment, it will be appreciated that the Volumizer mechanism can be implemented in alternative embodiments and be nonetheless effective to achieve the objects of the present invention. For instance, alternative embodiments of the Volumizer could be implemented through any mechanism which can effect a positive pressure differential.

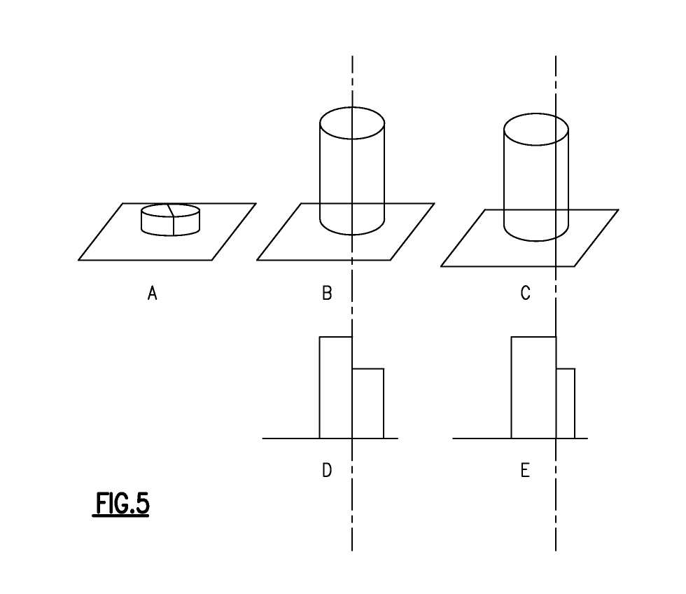

It can also be appreciated by one skilled in the art that the Volumizer can have additional mechanisms that allow for fine tuning its extension or retraction to give more flexibility and precise process control during more complex operations to increase or decrease volume at different rates and with different levels of precision. For instance, FIG. 4 shows another illustrative embodiment of a Volumizer with dual displacement capability. The Volumizer in its fully retracted position 400A is shown attached to a pressure vessel 401. The Volumizer has a first piston which can be extended into the vessel as shown by position 400B. The Volumizer also has a second controllable piston which can be extended further out into the vessel as shown by position 400C. The first and second pistons of the Volumizer can move independently of each other and can be controlled by separate actuators (not shown). The first and second pistons can be implemented in concentric fashion as shown, or in any other desired, suitable configuration, e.g., adjacent to each other, as in a longitudinally split (along or parallel to the center axis) cylinder, in any volume proportion (50/50, 60/40 etc.) as shown in FIGS. 5 A-E.

Alternatively, multiple Volumizers as shown in FIG. 2A of different or similar volume displacements can be disposed separately within the same vessel to offer more precise control capabilities. For example, a first Volumizer of a volume displacement V1 and a second Volumizer of a displacement V2 can both be disposed in the same vessel, and independently controlled.

While FIGS. 2A-D and FIGS. 3A-B show various implementations of the present invention for accomplishing the variation of volume within the pressure vessel for purposes of illustration, it will be appreciated by one skilled in the art that there many other ways of applying one or more combinations and/or variations of this teachings of the present invention based on e.g., the process conditions, engineering requirements, economics and other considerations for specific applications. For instance, instead of a welded connection that is built into a new fluid circuit design, the Volumizer can also be added to existing circuits as a retrofit by using an appropriate sealable connection. The Volumizer could also be mounted within a tee on a pipe in the fluid circuit. The size and shape of the Volumizer can be adapted based on process parameters such as, but not limited to, the materials used for the containment systems, maximum pressure of operation, differential pressure to be provided by the Volumizer, the geometry of the opening and the piston, the temperature and pressure ranges of the seawater/brine, the vapor pressure, the concentrations and compressibility of the medium, and the size and dimensions of the pressure vessels, valves, pumps, and other fluid circuit components. One skilled in the art will also appreciate that more than one Volumizer can be used within a vessel or section of pipe. Further, the influence of one Volumizer can also extend beyond one specific section of a pipe or vessel to a larger zone within the fluid circuit based on, among other things, the configuration of the fluid circuit, process conditions, the number and types of valves and other active and passive components that are used, as well as their sequence of operation. Similarly, alternative embodiments of devices and methods for varying the geometry and volume of fluid circuits may allow for controlling rates of deployment and retraction of the Volumizer.

It will be understood that while an illustrative embodiment has been described where an SWRO fluid circuit has two vessels, with each vessel having four valves, this illustrative embodiment is not meant to be limiting. The principles of the present invention can be applied in any fluid circuit process having any number or type of vessels, valves, Volumizers and feed back loops suitable to a particular application as will be understood by one skilled in the art.

The present invention has been illustrated and described with respect to specific embodiments thereof, which embodiments are merely illustrative of the principles of the invention and are not intended to be exclusive or otherwise limiting embodiments. For instance, although the description provided above along with the accompanying drawings illustrates particular embodiments incorporating one or a few features of the present invention, those skilled in the art will understand that alternative configurations can be devised and implemented, and that other designs capable of achieving the purpose and benefits of the discussed aspects of the invention are possible.

Accordingly, although the above description of illustrative embodiments of the present invention, as well as various illustrative modifications and features thereof, provides many specificities, these enabling details should not be construed as limiting the scope of the invention, and it will be readily understood by those persons skilled in the art that the present invention is susceptible to many modifications, adaptations, variations, omissions, additions, and equivalent implementations without departing from this scope and without diminishing its attendant advantages. It is further noted that the terms and expressions have been used as terms of description and not terms of limitation. There is no intention to use the terms or expressions to exclude any equivalents of features shown and described or portions thereof. It is therefore intended that the present invention is not limited to the disclosed embodiments but should be defined in accordance with the claims that follow.

What is claimed is:

1. An apparatus for varying volume in a pressurized fluid circuit having at least one vessel with an interior volume and at least two valves, wherein the apparatus comprises:
at least one housing mountable to the vessel; and
at least one actuatable member disposed in each housing, the actuatable member being in communication with the interior volume of the vessel,
wherein each actuatable member is actuatable to vary the interior volume, increasing or decreasing the volume when actuated.

2. The apparatus of claim 1, further comprising a control mechanism configured to control actuation of the actuatable member.

3. The apparatus of claim 2 wherein the control mechanism comprises closed loop feedback.

4. The apparatus of claim 2 wherein the control mechanism is open loop.

5. The apparatus of claim 1 wherein the actuatable member is a piston device.

6. The apparatus of claim 1 wherein the actuatable member is electrically driven.

7. The apparatus of claim 1 wherein the actuatable member is hydraulically driven.

8. The apparatus of claim 1 wherein the actuatable member is pneumatically driven.

9. The apparatus of claim 1 further comprising a mechanism to dynamically compensate for fluctuations in the compressibility of the fluid caused by fluctuations in process conditions.

10. The apparatus of claim 1 wherein each actuatable member is independently controllable.

11. A pressurized fluid circuit comprising:
at least one vessel with an interior volume;
at least two valves in association with the at least one vessel, the valves being operable to cause pressurization and depressurization of the fluid circuit; and
at least one pressurizing mechanism disposed in communication with the interior volume operable to vary the pressure of the interior volume of the at least one vessel,
wherein each pressurizing mechanism is operated in one state to augment the pressure of the interior volume of the at least one vessel and in another state to decrease the pressure.

12. The fluid circuit of claim 11 wherein the pressurizing mechanism comprises an actuatable member actuatable in one direction to augment the interior pressure and actuatable in an opposite direction to decrease the interior pressure.

13. A method for varying pressure in a fluid circuit having a pressurizable vessel having an interior volume capacity, the method comprising the steps of:
pressurizing the pressurizable vessel to a first operating pressure; and
varying the interior volume capacity at the first operating pressure to achieve at least a second operating pressure in the pressurizable vessel.

14. The method of claim 13 wherein the varying step comprises actuating a volumizing device which varies the interior volume capacity.

15. An apparatus for varying the volume in a pressurizable fluid circuit, the apparatus comprising:
a first pressure vessel in fluid communication with the fluid circuit and having a first actuatable member in communication with an interior volume of the first pressure vessel and configured to move between a first position and a second position to increase and decrease the interior volume of the first pressure vessel;
a second pressure vessel in fluid communication with the fluid circuit and having a second actuatable member in communication with an interior volume of the second pressure vessel and configured to move between a third position and a fourth position to increase and decrease the interior volume of the second pressure vessel;
wherein the first actuatable member and the second actuatable member are configured to work together to alternatingly pressurize and depressurize the first and second pressure vessels in a cyclical manner such that the interior pressure of the first pressure vessel increases as the interior pressure of the second pressure vessel decreases, and the interior pressure of the first pressure vessel decreases as the interior pressure of the second pressure vessel increases.

16. The apparatus of claim 15 wherein each actuatable member is independently controllable.

17. A pressurizable fluid circuit having an interior volume, comprising:
valves in association with the fluid circuit, the valves being operable to cause pressurization and depressurization of at least a portion of the fluid circuit; and
at least one pressurizing mechanism disposed in communication with the interior volume and being operable to vary the pressure of the interior volume of the portion of the fluid circuit,
wherein each pressurizing mechanism is operable in one state to augment the pressure of the interior volume and in another state to decrease the pressure of the interior volume.

18. The fluid circuit of claim 17 wherein each pressurizing mechanism is independently controllable.
